(19) United States
(12) Patent Application Publication
(10) Pub. No.: US 2007/0242071 A1
(43) Pub. Date: Oct. 18, 2007

(54) Character Display System

(76) Inventor: Patrick Myles Harding, Victoria (AU)

Correspondence Address: NEEDLE & ROSENBERG, P.C., SUITE 1000, 999 PEACHTREE STREET, ATLANTA, GA, 30309-3915, US

(21) Appl. No.: 11/596,819

(22) PCT Filed: May 20, 2005
(86) PCT No.: PCT/AU05/00726

§ 371 Date: May 25, 2007

(30) Foreign Application Priority Data
May 24, 2004 (AU) 2004902765

(51) Int. Cl. G06T 11/00

(52) U.S. Cl. 345/469.1

(57) ABSTRACT

A method and system for generating display data for a user interface, including: (i) receiving an input string including ideographic characters; (ii) selecting an ideographic character from said input string; (iii) generating a first word or phrase starting from said selected character, said first word or phrase corresponding to the largest plurality of consecutive ideographic characters from said input string corresponding to a word or phrase in a dictionary; (iv) generating additional words or phrases based on a plurality of consecutive ideographic characters from said input string starting from a character in said first word or phrase, for each character in said first word or phrase, each said additional word or phrase corresponding to a word or phrase in said dictionary; and (v) generating said display data for displaying a set of consecutive characters from said input string on said user interface, said set including all the characters from said first word or phrase and said additional words or phrases, said set being displayed based on the location of said additional words or phrases relative to said first word or phrase.

### FIELD

The present invention relates to a system and method for generating a display for displaying ideographic characters, and in particular, a display for indicating the boundary of words or phrases made up of ideographic characters.

The present invention also relates to a system and method for generating a display for presenting information related to a word or phrase made up of ideographic characters.

### BACKGROUND

The Chinese language may be more difficult to learn than, for example, an Indo-European language. One factor is that a person must learn a large number of Chinese characters before being able to read a passage of Chinese characters. There are approximately over 50,000 different traditional Chinese characters, of which approximately 5,000 to 8,000 are in common use. Of the 5,000 to 8,000 characters, around 3,000 characters are required for day-to-day usage. Chinese characters are ideographic characters, and each character has at least one meaning. Indo-European languages make use of a small standard set of phonetic symbols or characters which define an alphabet, and each word is made up of a unique combination of phonetic characters which has a particular meaning.

Another factor may be attributed to the different way in which words are defined in Chinese. In Indo-European languages, it is apparent where the word boundaries begin and end, since adjacent words are separated by a space or a small gap. In contrast, word boundaries in Chinese characters are weakly defined since there are no natural delimiters (e.g. spaces or gaps) between words, and the characters are typically written one next to another with no indication as to where words begin or end. However, punctuation symbols can help locate word boundaries. A person who can read Chinese characters can easily parse or interpret a string of Chinese characters and identify the relevant words. However, this skill is acquired through regular practise in recognising Chinese words and characters, and it is difficult to teach this skill to someone unfamiliar with the Chinese language or has a limited Chinese vocabulary.

Language learning tools typically include a text viewer with an enhanced display linked to a dictionary corpus. Such displays can help students identify individual words in a string, and may also display the meaning of a word when the word is selected (e.g. by clicking on it). It is more difficult to provide a similar learning tool that identifies Chinese words due to the complex nature of identifying word boundaries in Chinese.

The identification of word boundaries in a string of Chinese characters is a complex task, since a word in Chinese may be made up of one or more Chinese characters. Thus, determining whether a single character should be considered as a word by itself, or whether it should be combined with adjacent characters to form a word, involves considering the context in which that character is used in the sentence (e.g. by looking at the characters adjacent to that character). A further complication is that a single Chinese character may have more than one meaning. For example, the meaning of a particular character may be qualified or changed when placed adjacent to other characters or words. The proper meaning of a character will again depend on the context in which that character is used in the sentence. It is also possible for a set of characters forming one word to partially or wholly overlap with another set of characters forming another word. It is therefore difficult and complex to determine the meaning of a word comprising of multiple Chinese characters purely by resorting to the individual meaning of each character in the word.

The above problems described in the context of Chinese characters as an example, and similar problems arise in other languages based on ideographic characters (e.g. Japanese and Korean). It is therefore desired to provide a method and system that addresses the above or at least provides a useful alternative.

### SUMMARY

According to the present invention, there is provided a method for generating display data for a user interface, said method including:
(i) receiving an input string including ideographic characters;
(ii) selecting an ideographic character from said input string;
(iii) generating a first word or phrase starting from said selected character, said first word or phrase corresponding to the largest plurality of consecutive ideographic characters from said input string corresponding to a word or phrase in a dictionary;
(iv) generating additional words or phrases based on a plurality of consecutive ideographic characters from said input string starting from a character in said first word or phrase, for each character in said first word or phrase, each said additional word or phrase corresponding to a word or phrase in said dictionary; and
(v) generating said display data for displaying a set of consecutive characters from said input string on said user interface, said set including all the characters from said first word or phrase and said additional words or phrases, said set being displayed based on the location of said additional words or phrases relative to said first word or phrase.

The present invention also provides a system for performing a method as described above.

The present invention also provides a computer program product containing computer executable code for performing a method as described above.

The present invention also provides a system for generating display data for a user interface, including:
(i) means for receiving an input string including ideographic characters;
(ii) means for selecting an ideographic character from said input string;
(iii) a memory for storing the dictionary;
(iv) a word generator for:
   generating a first word or phrase starting from said selected character, said first word or phrase corresponding to the largest plurality of consecutive ideographic characters from said input string which corresponds to a word or phrase in said dictionary; and
   generating additional words or phrases starting from a character in said first word or phrase, for each character in said first word or phrase, each said additional word or phrase being generated based on a plurality of consecutive ideographic characters from said input string, and each said additional word or phrase corresponding to a word or phrase in said dictionary; and
(v) means for generating said display data for displaying a set of consecutive characters from said input string on said user interface, said set including all the characters from said first word or phrase and said additional words or phrases, wherein the displaying of said set of characters is based on the location of said additional words or phrases relative to said first word or phrase.

### BRIEF DESCRIPTION OF THE DRAWINGS

Preferred embodiments of the present invention are hereinafter described, by way of example only, with reference to the accompanying drawings, wherein:

FIG. 1 is block diagram of a display system which also shows the modules of the character processing system;

FIG. 2 is a flow diagram showing the steps for processing an input string received from the character input module for display;

FIG. 3 is a flow diagram showing the steps for determining the longest word that can be formed using consecutive characters from the input string starting from the selected character;

FIG. 4 is a flow diagram showing the steps for converting a Chinese character into a traditional Chinese character using both the character and variant dictionaries;

FIG. 5 is a flow diagram showing the steps for force converting a Chinese character into its traditional variant using the variant dictionary;

FIG. 6 is a flow diagram showing the steps for generating a list of words using each character in the longest word, and then determining whether the longest word is ambiguous;

FIG. 7 is a flow diagram showing the steps for generating a list of words starting from a root character in the longest word and using characters consecutively following the root character in the input string;

FIG. 8 is a flow diagram showing the steps for processing an input string received from the character input module in order to display descriptive data associated with words identified in the input string;

FIG. 9 is a flow diagram showing the steps for generating a list of words that are contained within the longest word;

FIG. 10 is a flow diagram showing the steps for looking up, retrieving and displaying data values from the character, compound and/or variant dictionaries corresponding to each entry in a list containing of characters or compound words;

FIG. 11 is a flow diagram showing the steps for generating a list of entries, each entry corresponding to a single character or a compound word, using the pinyin syllables derived from an input string containing one or more pinyin syllables;

FIG. 12 is a flow diagram showing the steps for generating a list of entries, each entry corresponding to a single character or a compound word, using keywords derived from an input string; and

FIG. 13 is a flow diagram showing the steps for generating a list of entries, each entry corresponding to a single character or a compound word, using the characters derived from an input string of characters;

FIG. 14 is a picture of stop characters;

FIG. 15 is a picture of punctuation characters;

FIG. 16 is a multicharacter word written in Chinese;

FIG. 17 is a multicharacter word written in Chinese; and

FIG. 18 is a number of single character words written in Chinese.

### DETAILED DESCRIPTION OF THE PREFERRED EMBODIMENTS

The preferred embodiments are described in the context of processing Chinese characters by way of example, and it will be understood that the preferred embodiments can be used for processing ideographic characters in other languages (such as Japanese or Korean characters).

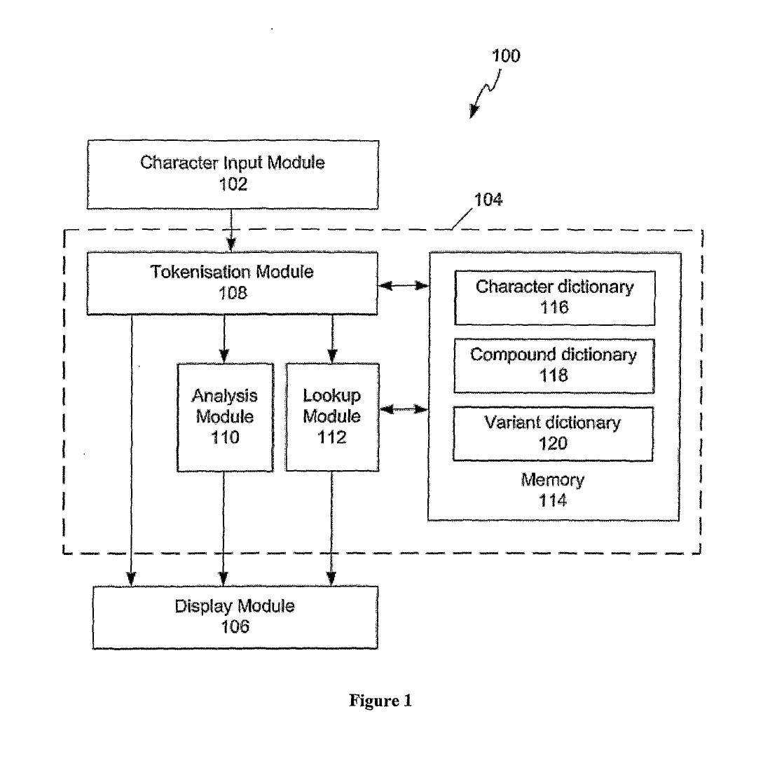

A processing system 100, as shown in FIG. 1, includes a character input module 102, a character processing module 104 and a display module 106. The character input module 102 receives an input string of Chinese characters from the user. For example, the character input module 102 generates a user interface (e.g. in the form of an input window or textbox for receiving one or more character entries) for the user to enter a string characters, and the user interface may receive an input string from a character input device (e.g. a keyboard, mouse or a character entry tablet, such as the PenPower Crystal Touch Chinese Writing Pad <http://www.penpower.com.tw/>) or a software input method (such as Microsoft's Global Input Method Editor, available from http://www.microsoft.com/windows/ie/downloads/recommended/ime/default.mspx). The character input module 102 forwards the input string to the character processing module 104.

The character processing module 104 processes the input string and sends the result (i.e. the display data generated by the character processing module 104) to the display module 106 for display (e.g. by updating the user interface generated by the character processing module 104). Display data represents one or more characters to be displayed, and also represents the display criteria for each of the characters to be displayed.

The character processing module 104, as shown in FIG. 1, includes a tokenisation module 108, analysis module 110, lookup module 112 and memory 114. The memory 114 includes any form of computer-readable storage medium (e.g. a hard disk, optical disk or magnetic tape, Random-Access Memory (RAM) and/or Read-Only Memory (ROM)). The memory 114 also contains a compound dictionary 116, character dictionary 118 and variant dictionary 120.

As shown in FIG. 1, the tokenisation module 108 in the character processing module 104 receives an input string of characters from the character input module 104 and determines, with reference to the character, compound, and variant dictionaries 116, 118, and 120 the longest word that can be formed using one or more consecutive characters from the input string starting from a particular character position (or cursor position) in the input string. If the character at the cursor position is a break character, the tokenisation module 108 passes the break character to the display module 106 for display.

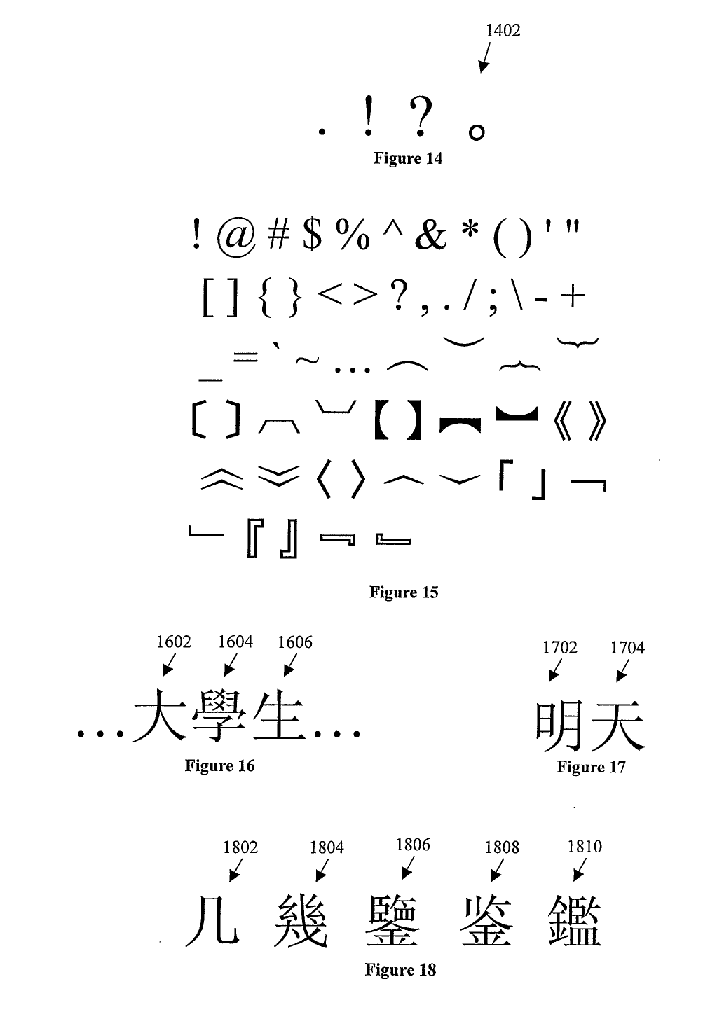

A break character is either an End-Of-File (EOF) character, a new line character, a stop character, or a punctuation character. A stop character defines the end of a sentence, and for example, includes the characters shown in FIG. 14. Stop characters include characters specific to a particular language which are used to define the end of a sentence, such as character 1402 in FIG. 14 being the equivalent of the full stop character in Chinese. Punctuation characters include a symbol or character that does not have any meaning and is not a stop character, an EOF character or new line character. Punctuation characters include the characters shown in FIG. 15, and those as further described in the Unicode Standard (Version 4.0.0) Chapter 6 “Writing Systems and Punctuation” (available from <http://www.unicode.org/versions/Unicode4.0.0/ch06.pdf>) the contents of which is hereby fully incorporated herein by reference. All characters that are not defined as break characters are referred to as non-break characters.

If the tokenisation module 108 determines that the longest word is a single character, the tokenisation module 108 passes the display data, which includes the character to be displayed, to the display module 106 for display. If the longest word includes two or more characters, the tokenisation module 108 generates a list of one or more compound words (i.e. words with two or more characters) using each character in the longest word as a starting character (i.e. root character), for each character in the longest word. Each compound word corresponds to a character or word in the character, compound and variant dictionaries 116, 118 and 120. Each compound word in the list starts with a root character, being a character in the longest word, and each compound word is formed using consecutive characters in the input string following and including the root character.

The list of one or more compound words is passed to the analysis module 110, which determines, based on the compound words in the list, whether the longest word is ambiguous because it contains entirely within it, or overlaps with, another compound word in the list. If so, the analysis module 110 generates display data, which includes the longest word, and passes this to the display module 106 for display. The display module 106 displays the longest word according to a display criteria defined in the display data for the characters in the longest word (e.g. to indicate that it is ambiguous) if the longest word contains entirely within it a compound word from the list. The display module 106 displays the longest word according to a different display criteria defined in the display data for the characters in the longest word (e.g. to indicate a different form of ambiguity) if the longest word overlaps with but does not contain entirely within it a compound word from the list. If the longest word is determined to be not ambiguous, the analysis module 110 passes display data, which includes the longest word, to the display module 106 for display as an unambiguous word according to yet a different display criteria defined in the display data.

Display criteria refers to the one or more conditions which define one or more visual characteristics for displaying a set of one or more characters. Conditions which may be used as display criteria include displaying a set of characters in a particular font type, font colour, font style (including bold, italic or underline), on a coloured background only for that character or set of characters (i.e. highlighting), or displaying the character or a set of characters in conjunction with other means of unique graphical identification (e.g. displaying the character in a box)), or any combination of one or more of the above conditions.

The lookup module 112 processes the list of words generated by the tokenisation module 108, and retrieves data values from the data fields in the character, compound and variant dictionaries 116, 118 and 120 associated with each compound word contained within the longest word. The retrieved data values are then passed to the display module 106 for display.

The modules in the processing system 100 may be implemented in software and executed on a standard computer (such as that provided by IBM Corporation <http://www.ibm.com>) running a standard operating system, such as Windows or Unix. Those skilled in the art will also appreciate the processes performed by the components can also be executed at least in part by dedicated hardware circuits, e.g., Application Specific Integrated Circuits (ASICs) or Field-Programmable Gate Arrays (FPGAs). The processes performed by the processing module 100 may be implemented as a standalone application, or as a plug-in software component which interacts with the default input and display components of a standard operating system, such as any version of the Microsoft Windows operating system (<http://www.microsoft.com/windows/>).

The character dictionary 116 associates an identifier representing a particular ideographic character (e.g. a traditional Chinese character). Each character in the character dictionary 116 is associated with a list of one or more objects, each object containing one or more values. The values may correspond to phonetic data, audio data and/or definition data. Phonetic data represents a phonetic representation of that particular character (e.g. in pinyin). Audio data represents an audio representation of the corresponding character. The audio representation preferably includes an audio file (or a pointer including a path and/or filename to such a file) stored in memory 114. The data in the audio file may represent an analog or digitised audio signal which can be later reproduced as sound waves to illustrate to a user the pronunciation of that character. Definition data represents a definition (e.g. in the form of a string) corresponding to the meaning or meanings for that particular character (e.g. the translated meaning of that character in another language, such as English). Each ideographic character has meaning, and can therefore be considered as a word by itself.

The character dictionary 116 may be implemented as a hash map stored in memory 114, which associates an identifier (e.g. a Unicode character code for a character) with the list of one or more objects. The Unicode Standard (available from <http://www.unicode.org/>) is a standard for encoding characters wherein each character, symbol or letter in any language is assigned a unique hexadecimal numeric identifier called the Unicode character code. In a preferred embodiment, only Unicode character codes corresponding to traditional Chinese characters (as defined in the CJK Unified Ideographs Standard (Range: 4E00-9FAF), available from <http://www.unicode.org/charts/PDF/U4E00.pdf>) are used to identify characters in the XML character data file and in the character dictionary 116. In other preferred embodiments, Unicode character codes corresponding to ideographic characters in other languages can be used (e.g. Unicode character code definitions for other ideographic characters are available from <http://www.unicode.org/charts/>).

The character dictionary 116 may also be implemented as one or more tables in a relational database, or as a multi-dimensional array associating a unique identifier with one or more values (e.g. where each element in the one or more tables or array associates a unique Unicode character code with a list containing one or more list elements).

The hash map corresponding to the character dictionary 116 may be generated using data contained in one or more structured data files (e.g. an Extended Markup Language (XML) file) stored in memory 114. Listing 1, as shown below, is an example of a data fragment corresponding to a single character entry (or glyph) from an XML character data file. This XML character data file contains data entries corresponding to one or more characters, each of which is used to generate an entry in the character dictionary 116. The data for each character is stored within the <glyph> and </glyph> tags. Each entry is identified by the unique Unicode character code for each character, which is stored within the <unicode> and </unicode> tags.

The XML character data file stores definition of the characters in the form of a string within the <kDefinition> and </kDefinition> tags. The definition may be the corresponding meaning of the character expressed in any language (including Chinese). The XML character data file also stores the phonetic representation for each character (e.g. in pinyin) within the <pinyin> and </pinyin> tags. The phonetic representation of a Chinese character can be described in a romanised script called pinyin. Each ideographic character may correspond to one or more pinyin syllables, each syllable consisting of a sound component and a tone component. The pinyin syllable for each character may be represented using a combination of a text component (corresponding to the sound component) and a tone identifier (to identify the tone component). The text component is the romanised representation of the sound for a particular character, and the tone identifier indicates the tone in which that character should be pronounced. Preferably, the written phonetic representation for each character is based on the Chinese Putonghua (or Mandarin) dialect. Accordingly, the tone identifier is preferably a numeric identifier ranging from 1 to 5 which corresponds to each of the five standard tones defined for Putonghua pinyin. For example, the digit “1” represents a first tone corresponding to a high even pitch. The digit “2” represents a second tone corresponding to a rising pitch. The digit “3” represents a third tone corresponding to a falling then rising again pitch. The digit “4” represents a fourth tone corresponding to a falling pitch. And similarly, the digit “5” represents a fifth tone corresponding to a neutral (or silent) pitch. Thus, in the pinyin representation shown in Listing 1, the character identified as Unicode character code “53e3” has a Putonghua pinyin representation of “kou3”, which indicates that the character is pronounced as the “kou” sound and in the third tone.

However, a single written Chinese character can be pronounced differently in a different Chinese dialect. Each character will have a different written phonetic representation corresponding to a particular spoken dialect. Thus, for example, the written phonetic representation stored for each character in the character dictionary 116 can be the pinyin representation based on another Chinese dialect (e.g. based on the Cantonese pinyin). In general, it is preferable that the written phonetic representation for all character in the character dictionary 116 be consistently associated with the pinyin representation from a common single dialect. In other embodiments of the present invention, each character may individually be associated with one or more different pinyin representations, corresponding to the pronunciations in different dialects. In such a case, it is preferable that each character in the character dictionary 116 be consistently associated with the same set of different pinyin representations corresponding to the same set of different dialects.

The following is an example illustrating how data corresponding to a Chinese character stored in an XML character data file is extracted and used to generate an entry in the character dictionary 116. The character shown in Listing 1 is identified by the Unicode character code “53e3”. When the XML character data file is parsed, for example using any conventional parsing technique, the Unicode character code is extracted from each entry in the XML character data file to form the key for a corresponding entry in the character dictionary 116. This key uniquely identifies a particular entry in the hash map corresponding to a character in the character dictionary 116. For example, the hash map corresponding to the character dictionary 116 may be generated by associating each key with a list of one or more objects, wherein each object is associated with definition data (e.g. a translation string), phonetic data representing a phonetic representation of that character (e.g. in pinyin), and/or audio data representing the character (e.g. as an audio signal or audio file).

Listing 2, as shown below, is an example of a fragment corresponding to a single character entry from an XML character data file, in which the same character (identified as Unicode character code “4f9b”) can be pronounced in different tones (i.e. “gong1” and “gong4”) and a different meaning is associated with each pronunciation. In this case, the entry identified by “4f9b” in the hash map corresponding to the character dictionary 116 is a list containing two objects. A first object contains the phonetic data and definition data corresponding to “gong1” (i.e. the pinyin syllable “gong1” and the translation string “supply; provide;” respectively). A second object contains the phonetic data and definition data corresponding to “gong4” (i.e. the pinyin “gong4” and the translation string “lay (offerings); confess; own up;” respectively).

The compound dictionary 118 associates an identifier representing a compound word or phrase. A word includes a single character (e.g. as stored in the character dictionary 116) or a combination of two or more characters (e.g. as stored in the compound dictionary 118). A phrase includes a combination of two more characters, and is stored only in the compound dictionary 118. The identifier for a word/phrase in the compound dictionary 118 may be associated with a list of one or more objects, each object containing one or more values. The values may correspond to phonetic data, audio data and/or definition data for that word/phrase. Preferably, the characters for each word/phrase in the compound dictionary 118 are traditional Chinese characters.

For each word/phrase in the compound dictionary 118, the phonetic data represents a phonetic representation of that compound word (e.g. in pinyin). The audio data represents an audio representation of corresponding word/phrase, such as in the form of an audio file (or a pointer including a path and/or filename to such a file) stored in memory 114. For example, the data in the audio file may represent an analog or digitised audio signal which can be later reproduced as sound waves to illustrate to a user the pronunciation of that word/phrase. The definition data represents a definition (e.g. in the form of a string) corresponding to the meaning of the word/phrase (e.g. the translated meaning of that compound word in another language, such as English).

The compound dictionary 118 may be implemented as a hash map stored in memory 114, which associates an identifier (e.g. a unique combination of Unicode character codes corresponding to each character in the word/phrase to uniquely identifying the word/phrase as a compound word) with a list of one or more objects, each object containing one or more values. Alternatively, the compound dictionary 118 may be implemented as one or more tables in a relational database, or as a multi-dimensional array (as described above), each associating a unique identifier formed using a combination of Unicode character codes with a list of objects, each containing one or more values. The compound dictionary 118 may use Unicode character codes corresponding to ideographic characters in other languages to identify word/phrases in another language. Unicode character code definitions for other ideographic characters are available from <http://www.unicode.org/charts/>.

The hash map corresponding to the compound dictionary 118 may be generated using data contained in one or more structured data files (e.g. an Extended Markup Language (XML) file) stored in memory 114. Listing 3, as shown below, is an example of a data fragment corresponding to a compound word entry from an XML compound word data file. This XML compound word data file contains data entries corresponding to one or more compound words, each of which is used to generate an entry in the compound dictionary 118. The data for each compound word is stored within the <compound> and </compound> tags.

Each compound word includes at least two characters, a <tuple> tag is defined for each character in the compound word. A <tuple> tag may include an identifier (e.g. a plurality of Unicode character codes) and a phonetic representation (e.g. in pinyin) of each character in a compound word. The order of the characters is important. For example, referring to Listing 3 and FIG. 17, the character identified by a Unicode character code of “660e” corresponds to character 1702 in FIG. 17, and the character identified by a Unicode character code of “5929” corresponds to character 1704 in FIG. 17. In that order (i.e. where character 1702 is placed before character 1704) the characters 1702 and 1704 forms a Chinese word meaning “tomorrow”. If these two characters are arranged in a different way, the characters will not have the same meaning. The order of the characters are stored in their order of appearance in the XML compound word data file, such that in this example the character data for character 1702 (identified as “660e”) appears before the character data for character 1704 (identified as “5929”). The English meaning of the compound word (i.e. definition data in the form of a translation string for the compound word) is defined within the <english> and </english> tags. However, it will be understood that the translation string can be the meaning of the compound word expressed in any written language. Further tags can also be defined for other data corresponding to a particular compound word, for example, a tag defining the path and filename of an audio file, or a pointer to such a file, corresponding to the audio representation of that compound word.

The following is an example illustrating how data corresponding to a compound word is extracted from an entry in a XML compound word data file and used to generate an entry in the compound dictionary 118. The compound word entry shown in Listing 3, comprises two characters (corresponding to characters 1702 and 1704 in FIG. 17) which are respectively identified by the Unicode character codes “660e” and “5929”. When the XML compound word data file is parsed, for example using any conventional parsing technique, the Unicode character code for each character in that entry is extracted and then concatenated in their order of appearance to form a key in the compound dictionary 118. In the example shown in listing 3, the Unicode character codes for each character in the compound word entry shown in Listing 3 are concatenated to form the string “660e5929”, which is used as the key for a corresponding entry in the compound dictionary 118. This key uniquely identifies a particular entry in the hash map corresponding to a compound word in the compound dictionary 118. For example, the hash map corresponding to the compound dictionary 118 may associate each key with a list of one or more objects, wherein each object is associated with definition data (e.g. a translation string which corresponds to the meaning of that compound word), phonetic data representing a phonetic representation of that compound word (e.g. in pinyin) and/or audio data representing the compound word (e.g. as an audio signal or audio file). The pinyin representation stored in a hash map corresponding to a compound word may be formed by concatenating the pinyin syllables for each character in the compound word, and may have a space between each of the concatenated pinyin syllables. For example, the compound word made up of characters 1702 and 1704, as shown in FIG. 17, is identified by the concatenated Unicode character code key of “660e5929” and corresponds to a phonetic representation of “ming2 tian1”.

Preferably, only Unicode character codes corresponding to traditional Chinese characters (e.g. as defined in the CJK Unified Ideographs Standard (Range: 4E00-9FAF), available from <http://www.unicode.org/charts/PDF/U4E00.pdf>) are used to identify characters in the character and compound dictionaries 116 and 118, and respectively in the corresponding XML character data file and XML compound word data file.

The variant dictionary 120 includes an entry for every traditional and simplified Chinese character (e.g. as defined in the CJK Unified Ideographs Standard (Range: 4E00-9FAF)) and associates each of those characters with a list of one or more object, each object containing one or more values. The values may correspond to a list of one or more corresponding traditional variant characters, a corresponding simplified variant character, or a list of one or more corresponding semantic variant characters.

An example is illustrated with reference to Listing 4, which shows three data fragments corresponding to different character entries contained in an XML variant data file. Each entry in the XML variant data file corresponds to a character, which is identified by its Unicode character code and stored within the <unicode> and </unicode> tags. For example, referring to FIG. 18, the traditional Chinese character identified using Unicode character code “9452” (shown as character 1806 in FIG. 18) can also be written as the simplified Chinese character corresponding to Unicode character code “9274” (shown as character 1808 in FIG. 18). Thus, in the example shown in Listing 4, the character identified as “9274” (i.e. character 1808 in FIG. 18) is defined as the simplified variant of the character identified as “9452” (i.e. character 1806 in FIG. 18). Furthermore, the simplified variant “9274” is stored within the <kSimplifiedVariant> and </kSimplifiedVariant> tags under the character entry identified by the Unicode character code “9452”. As a further example, the traditional Chinese character identified using Unicode character code “9452” (i.e. character 1806 in FIG. 18) has a similar meaning as another traditional Chinese character corresponding to Unicode character code “9451” (shown as character 1810 in FIG. 18), although both characters are written differently. Thus, the character identified as “9451” (i.e. character 1810 in FIG. 18) is the semantic variant of the character identified as “9452” (i.e. character 1806 in FIG. 18). As shown in Listing 4, the semantic variant “9451” (i.e. character 1810 in FIG. 18) is stored within the <kSemanticVariant> and </kSemanticVariant> tags under the character entry identified by the Unicode character code “9452” (i.e. character 1806 in FIG. 18).

Similarly, a simplified Chinese character can be written in a particular traditional Chinese character. For example, the character identified using Unicode character code “9274” (i.e. character 1808 in FIG. 18) may correspond to either the traditional character corresponding to Unicode character code “9451” (i.e. character 1810 in FIG. 18) or the traditional character corresponding to Unicode character code “9452” (i.e. character 1806 in FIG. 18). Preferably, when there are more than one traditional variant character associated with a particular entry, each of these traditional variant characters are ordered by popularity.

When the XML variant data file is parsed, for example using any conventional parsing technique, the Unicode character code identifying each entry in the XML variant file is extracted to form a key for a corresponding entry in the variant dictionary 120. This key uniquely identifies a particular entry in the hash map corresponding to a character in the variant dictionary 120. For example, the hash map corresponding to the variant dictionary 120 may associate each key with a list of one or more objects, wherein each object has a list containing one or more traditional variant characters, a simplified variant character, and/or a list of one or more semantic variant characters.

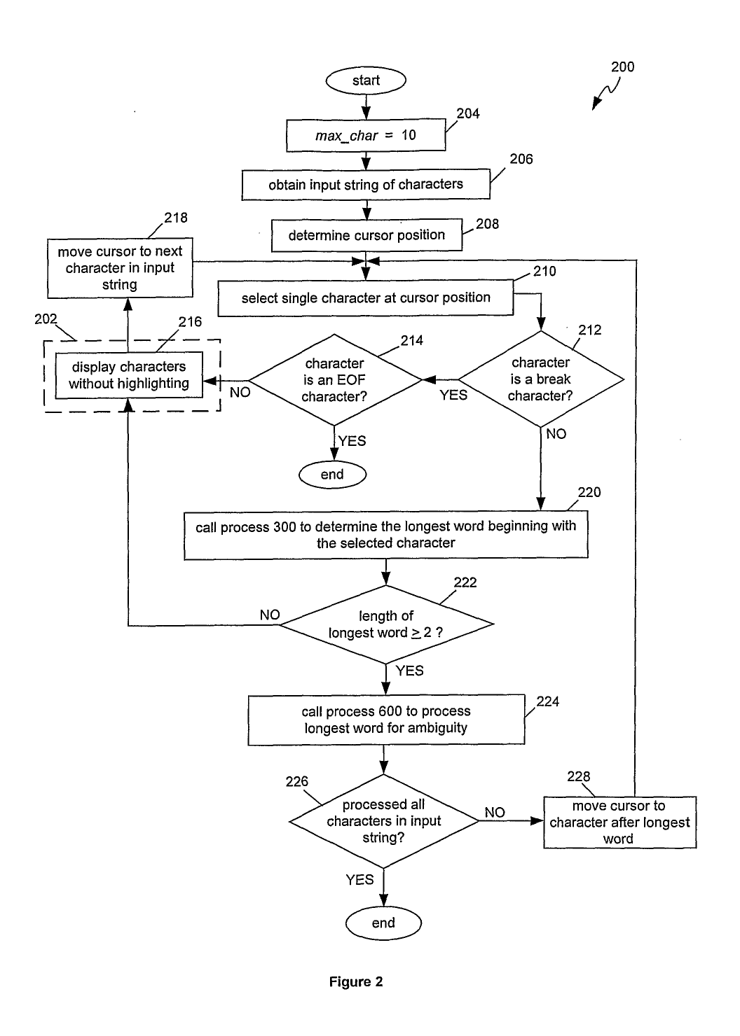

The flow diagram in FIG. 2 shows the process 200 for processing an input string received from the character input module 102 for display. Process 200 processes the input string to identify words (includes compound words and phrases), and generates display data for displaying those words based on whether those words are non-ambiguous or ambiguous (e.g. for containing wholly with it, or overlapping with, another word). Process 200 is executed in the tokenisation module 108, except that the step shown in box 202 is performed in the display module 106. Process 200 begins at step 204 by setting a global variable, max_char, to define the maximum number of consecutive characters from the input string to search in order to determine whether those consecutive characters correspond to, contain within them or overlaps with, a compound word. The variable max_char may have a value between 7 and 15, but preferably, max_char is set to a value of 10. At step 206, an input string of characters is obtained from the character input module 102. Then, at step 208, the user is required to determine a starting character position (or cursor position) being a character in the input string of characters from which the search for compound words begins. At step 210, the character at the cursor position is elected as the selected character. At step 212, the selected character is analysed to determine if it is a break character. If the selected character is a break character, the process continues at step 214, where it is determined whether the selected character is an EOF character. If step 214 determines that the selected character is an EOF character, the process ends. Otherwise, step 214 proceeds to step 216 by displaying the selected character. For example, step 216 may generate display data for displaying the character on a standard white coloured background.

At step 218, the cursor position is advanced to the next character in the input string. Then, at step 210, the character at the new cursor position is selected as the new selected character and process 200 continues to process the character at the new cursor position, as described above. However, if the selected character is not determined to be a break character at step 212, the process proceeds to step 220 by calling process 300 to determine the longest word that can be formed using consecutive characters from the input string starting from and including the selected character. If the character length of the longest word determined at step 220 is greater than or equal to 2 (i.e. the longest word contains two or more characters), the process proceeds to step 224 for processing the longest word for ambiguity using process 600. Otherwise, step 222 proceeds to step 216 to generate display data for displaying the longest word. After the longest word has been processed for ambiguity at step 224, step 226 determines whether all the characters in the input string have been processed. If so, the process ends. Otherwise, at step 228, the cursor is advanced to the character immediately following the longest word in the input string, and the character at the new cursor position will be selected as the new selected character at step 210.

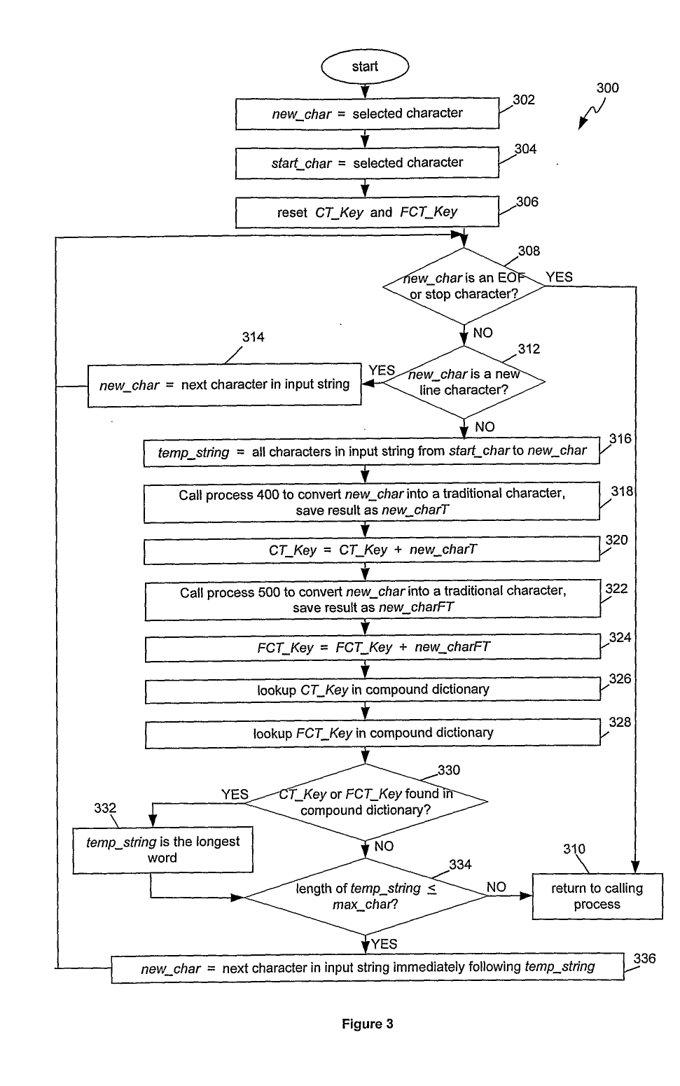

The flow diagram in FIG. 3 shows the process 300 for determining the longest word that can be formed using consecutive characters from the input string starting from the selected character. Process 300 is executed in the tokenisation module 108. Process 300 begins at step 302 where the variable for storing a new character, new_char, is initially defined as the character selected at the cursor position in step 210 of process 200. At step 304 the variable start_char, which represents the first possible character of the set of characters corresponding to the longest word, is also defined as the character selected at the cursor position in step 210 of process 200. At step 306, the variables for the lookup keys, CT_Key and FCT_Key, are reset to a null or empty string. Step 306 proceeds to step 308, which determines whether the character defined as new_char is an EOF or stop character. If so, step 308 proceeds to step 310 where execution continues at step 222 of process 200. Otherwise, step 308 proceeds to step 312, which determines whether the character defined as new_char is a new line character. If so, at step 314, the next character in the input string immediately following the new line character is defined as the new character, new_char, and step 314 proceeds to step 308. Otherwise, step 312 proceeds to step 316, where the variable temp_string is defined as including all the character in the input string starting from the character defined as start_char up to and including the character currently defined as new_char.

At step 318, process 400 is used to convert the character defined as new_char into a traditional Chinese character, and the result is saved as in the variable, new_charT. Then, at step 320, the traditional Chinese character defined as new_charT is added to the existing lookup key defined as CT_Key, and the updated result is saved as the variable CT_Key. At step 322, process 500 is used to force converted the character defined as new_char into a traditional Chinese character, and the result is saved in the variable, new_charFT. Then, at step 324, the traditional Chinese character defined as new_charFT is added to the existing lookup key defined as FCT_Key, and the updated result is saved as the variable FCT_Key.

At steps 326 and 328, the respective Unicode representation of CT_Key and FCT_Key are used in separate attempts to lookup the compound dictionary 118 for a matching entry. The Unicode representation of each of the two keys may be respectively formed by the concatenation of the Unicode character codes for each character in those keys in the order which the characters appear in each key.

Step 330 then determines whether the Unicode representation of CT_Key or FCT_Key was found in the compound dictionary 118. If so, the string of characters defined as temp_string is defined as the longest word at step 332. Otherwise, it is determined at step 334 whether the character length of temp_string (i.e. the number of characters contained in the string defined as temp_string) exceeds the maximum number of characters to search, as defined by the variable max_char. If it is determined at step 334 that the number of characters in temp_string is less than or equal to the maximum number of characters to search as defined by max_char, then at step 336 the next character in the input string immediately following the last character in temp_string is defined as the new character, new_char. Otherwise, the process proceeds to step 310, where execution resumes in the process which made the call to execute process 300, at the point after which the call to execute process 300 was made (e.g. at step 222 in process 200, or at step 802 in process 800).

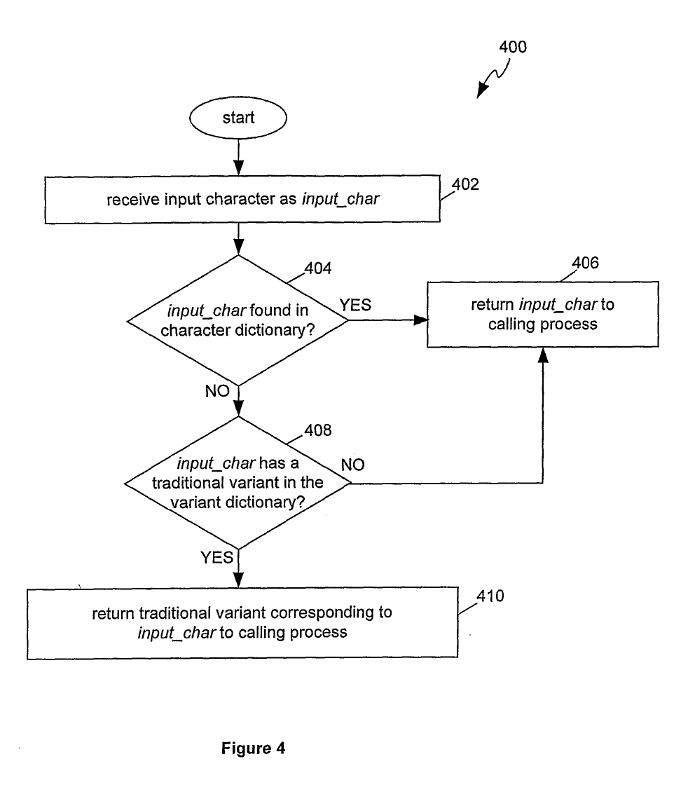

The flow diagram in FIG. 4 shows the process 400 for converting any Chinese character into a traditional Chinese character using both the character and variant dictionaries 116 and 120. Process 400 is executed in the tokenisation module 108. Process 400 begins at step 402, where the character to be converted into a traditional Chinese character is defined as the variable, input_char. At step 404, it is determined whether the Unicode character code corresponding to the character defined as input_char exists in the character dictionary 116. Where the character dictionary 116 only contains entries identified by the Unicode character codes for traditional Chinese characters, if the Unicode representation of input_char is found in the character dictionary 116 it must be a traditional Chinese character. Thus, if a corresponding entry is found in the character dictionary 116 at step 404, then at step 406, the character defined as input_char is returned to the process which made the call to execute process 400, and execution resumes at the point after which the call to execute process 400 was made (e.g. at step 320 in process 300, or at step 716 in process 700). Otherwise, step 404 proceeds to step 408, where it is determined whether the Unicode character code corresponding to the character defined as input_char can be found in the variant dictionary 120, and if so, whether the entry for input_char also has a corresponding traditional variant character. If so, step 408 proceeds to step 410, where the traditional variant character from the variant dictionary 120 corresponding to the character defined as input_char is returned to the process which made the call to execute process 400, and execution resumes at the point after which the call to execute process 400 was made (e.g. at step 320 in process 300, or at step 716 in process 700). Otherwise, step 408 proceeds to step 406.

The flow diagram in FIG. 5 shows the process 500 of force converting a Chinese character into its traditional variant using the variant dictionary 120. Process 500 is executed in the tokenisation module 108. Process 500 begins at step 502, where the character to be converted into a traditional Chinese character is defined as the variable, in_char. At step 504, it is determined whether the Unicode character code corresponding to the character defined as in_char can be found in the variant dictionary 120, and if so, whether the entry for in_char has a corresponding traditional variant character. If so, step 504 proceeds to step 506, where the traditional variant character from the variant dictionary 120 corresponding to the character defined as in_char is returned to the process which made the call to execute process 500, and execution resumes at the point after which the call to execute process 500 was made (e.g. at step 324 in process 300, or at step 720 in process 700). Otherwise, step 504 proceeds to step 408, where the character defined as in_char is returned to the process which made the call to execute process 500, and execution resumes at the point after which the call to execute process 500 was made (e.g. at step 324 in process 300, or at step 720 in process 700).

Some Chinese characters may be a traditional Chinese character, but the same character may also be a simplified character for another traditional Chinese character. For example, with reference to FIG. 18, the character 1802 (corresponding to Unicode character code “51e0”) is itself a traditional Chinese character meaning “a small table”. However, the same character is also the simplified character for the traditional Chinese character 1804 as shown in FIG. 18 (corresponding to Unicode character code “5e7e”) which means “how many; several; a few; some”. The effect of process 400 is that if the original character to be converted (i.e. the character defined as input_char) is itself a traditional character, process 400 will return that original character. However, the effect of process 500 is that if the original character to be converted (i.e. the character defined as in_char) is a character which has a traditional variant, then regardless of the fact that the character defined as in_char is a traditional character, process 500 will always return the corresponding traditional variant character.

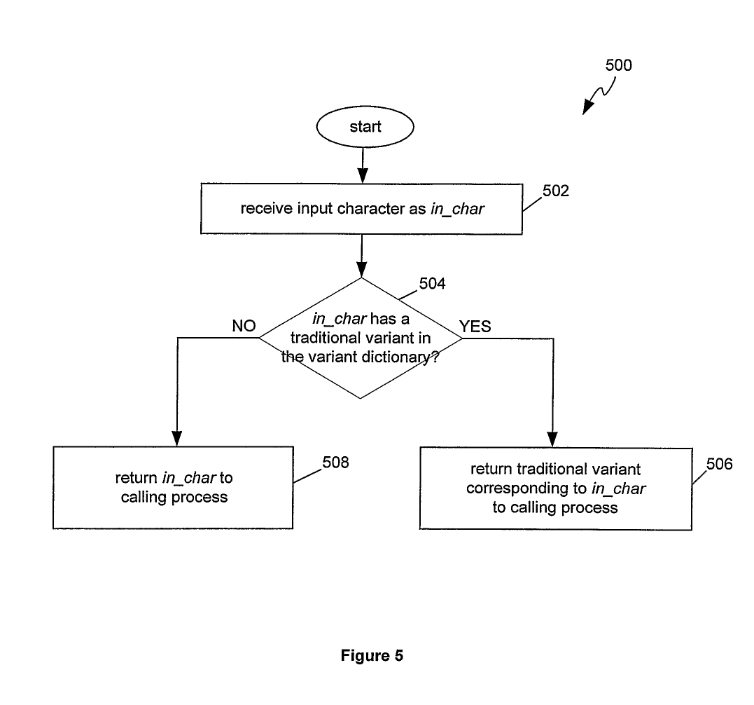

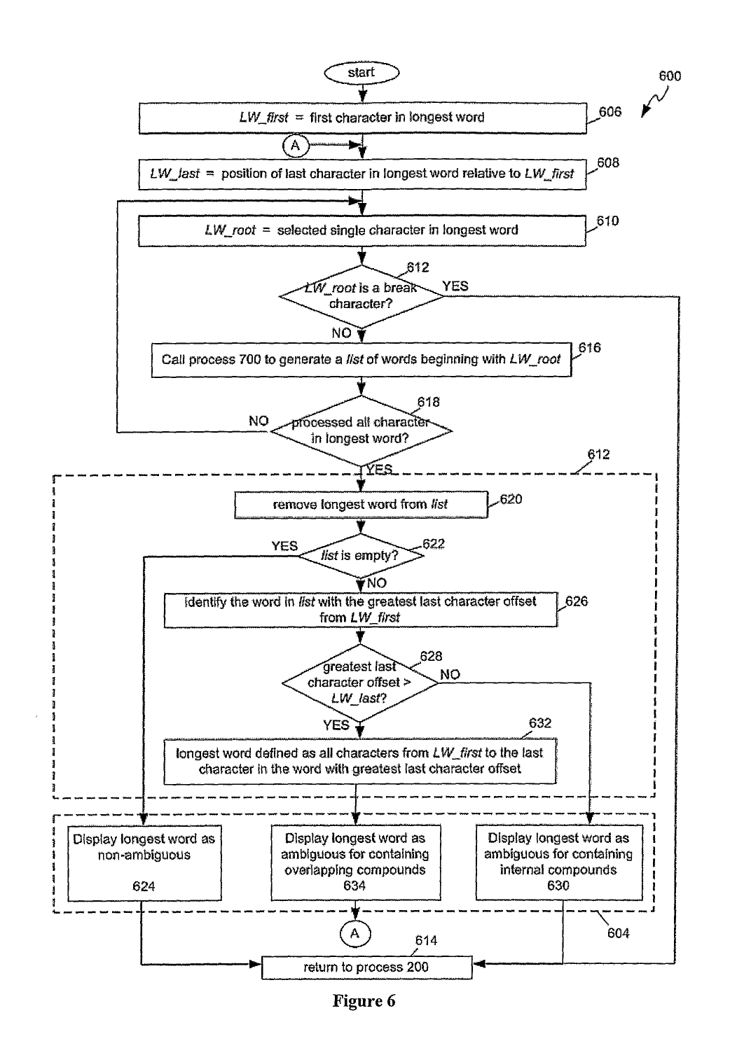

The flow diagram in FIG. 6 shows the process 600 for generating a list of words using each character in the longest word as a starting character, and then determining whether the longest word is ambiguous based on the list of words. The list of words contains compound words, and as such, includes phrases. The steps shown in box 602 are executed in the analysis module 110 and the steps shown in box 604 are executed in the display module 106. The remaining steps in process 600 are executed in the tokenisation module 108. Process 600 begins at step 606, where first character in the longest word is defined as the variable LW_first. At step 608, the character position of the last character in the longest word is defined as the variable LW_last. LW_last represents the character offset of the last character in the longest word relative to the first character of the longest word.

At step 610, a root character is selected for use as the starting character for generating a list of words beginning with that character. At step 610, the variable LW_root, representing the root character, is initially defined as the first character in the longest word. It is then determined, at step 612, whether the character defined as LW_root is a break character. If so, step 612 proceeds to step 614, where execution resumes at step 226 in process 200. Otherwise, step 612 proceeds to step 616, where process 700 is used to generate a list of compound words, where each compound word in the list starts with the character defined as LW_root, and each compound word in the list is made up of characters in the input string consecutively following and including the character defined as LW_root. Each of the compound words formed are stored in a list, identified by the handle, list. After a list of words has been generated, step 618 determines whether all the characters in the longest word have been processed (i.e. whether each character in the longest word has been defined as LW_root to generate a list of words starting from that character). If not, step 618 proceeds to step 610 where the next character in the input string immediately following the character currently defined as LW_root is selected as the new root character, and the variable LW_root is then updated to refer to the new root character. Otherwise, step 618 proceeds to step 620.

Since the words defined in the list of words (identified as list) will always contain the longest word, at step 620, the longest word is removed from the list of words. At step 622, it is determined whether the list of words is empty. If so, this indicates that no further words (other than the longest word) can be formed from the combinations of consecutive characters starting from each character in the longest word. In other words, an empty list indicates that longest word is unambiguous because it does not contain wholly within it, or overlaps with, another word. Thus, if the list of words is empty, step 622 proceeds to step 624 where the longest word is displayed as unambiguous. For example, at step 624, all the characters in a single unambiguous compound word are generated for display according to a display criteria that highlights the compound word (i.e. displays the compound word on a coloured background) in one of two background colours in alternating sequence, such that a compound word is highlighted using one background colour and the following compound word is highlighted using another background colour. Step 624 may highlight a first unambiguous compound word using a first background colour (e.g. grey) and highlight the next unambiguous compound word in a second background colour (e.g. blue). The next unambiguous compound word will then be highlighted using the first background colour (e.g. grey), and so on such that the background colours are applied in alternating sequence. Step 624 continues to step 614 where execution resumes at step 226 in process 200.

If it is determined at step 622 that the list of words is not empty, step 622 proceeds to step 626, where each word in the list of words is processed to identify a compound word from the list defined as list, the last character of which has the greatest character offset from the character defined as LW_first. At step 628, it is determined whether the character offset of the last character of the compound word determined in step 626 is greater than the character offset of the character defined as LW_last (i.e. the last character in the longest word). If step 628 determines that the character offset of LW_last has not been exceeded, the longest word therefore contains other compound words wholly within it and step 628 proceeds to step 630 to generate display data for displaying the current longest word as ambiguous for containing internal compounds. For example, step 630 may generate display data for displaying all the characters in the longest word according to a display criteria (e.g. displaying those characters on a particular background colour, such as pale green). Step 630 continues to step 614 where execution resumes at step 226 in process 200.

Otherwise, step 628 proceeds to step 632, since the longest word therefore overlaps with another word which extends beyond the last character of the current longest word. At step 632, the longest word is redefined to include all character from the input string starting from LW_first (i.e. the first character of the longest word) up to and including the last character of the word with the greatest last character offset (determined in step 626). Step 634 generates display data for displaying the updated longest word as ambiguous for containing overlapping compounds. For example, at step 634, all the characters in the updated longest word are generated for display according to a display criteria (e.g. displaying those characters on a particular background colour, such as pale orange). Step 634 continues to step 608, where the variable LW_last is updated with the character position of the new last character of the updated longest word. Then, at step 610, the character immediately following the longest word (before it was updated) is selected as the next root character, and is defined as LW_root.

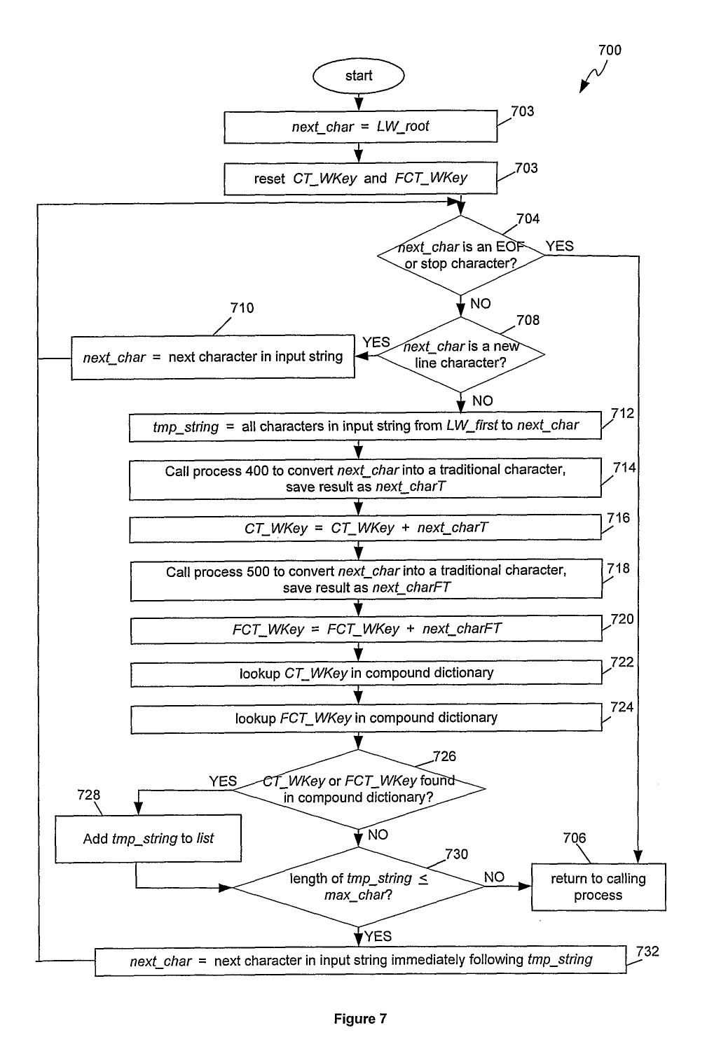

The flow diagram in FIG. 7 shows the process 700 for generating a list of words starting from a particular root character in the longest word and using characters consecutively following the root character in the input string. Process 700 is executed in the tokenisation module 108. Process 700 begins at step 702 where the root character from process 600 is initially used as the first character for generating one or more compound words, and so is defined as the variable, next_char. At step 703, the variables for the lookup keys, CT_WKey and FCT_WKey, are reset to a null or empty string. At step 704, it is determined whether the character defined as next_char is an EOF character or stop character. If so, step 704 proceeds to step 706, where execution resumes in the process which made the call to execute process 700, at the point after which the call to execute process 700 was made (e.g. at step 618 in process 600, or at step 618 in process 900). Otherwise, step 704 proceeds to step 708, where it is determined whether the character defined as next_char is a new line character. If so, at step 710, the next character in the input string immediately following the new line character in defined as the next character, next_char, and step 710 proceeds to step 704. Otherwise, step 708 proceeds to step 712, where the variable tmp_string is defined as including all the character in the input string starting from the character defined as LW_first up to and including the character currently defined as next_char.

At step 714, process 400 is used to convert the character defined as next_char into a traditional Chinese character, and the result is saved as in the variable, next_charT. Then, at step 716, the traditional Chinese character defined as next_charT is added to the existing lookup key defined as CT_WKey, and the updated result is saved as the variable CT_WKey. At step 718, process 500 is used to force converted the character defined as next_char into a traditional Chinese character, and the result is saved in the variable, next_charFT. Then, at step 720, the traditional Chinese character defined as new_charFT is added to the existing lookup key defined as FCT_WKey, and the updated result is saved as the variable FCT_WKey.

At steps 722 and 724, the respective Unicode representation of CT_WKey and FCT_WKey are used in separate attempts to lookup the compound dictionary 118 for a matching entry. The Unicode representation of each of the two keys may be respectively formed by the concatenation of the Unicode character codes for each character in those keys in the order which the characters appear in each key.

It is then determined, at step 726, whether the Unicode representation of CT_WKey or FCT_WKey was found in the compound dictionary 118. If so, at step 728, the string of characters defined as tmp_string is added to the list of words, defined as list. Otherwise, it is determined at step 730 whether the character length of tmp_string (i.e. the number of characters contained in the string defined as tmp_string) exceeds the maximum number of characters to search, as defined by the variable max_char. If it is determined at step 730 that the number of characters in tmp_string is less than or equal to the maximum number of characters to search as defined by max_char, then at step 732 the next character in the input string immediately following the last character in tmp_string is defined as the next character, next_char. Otherwise, step 730 proceeds to step 706.

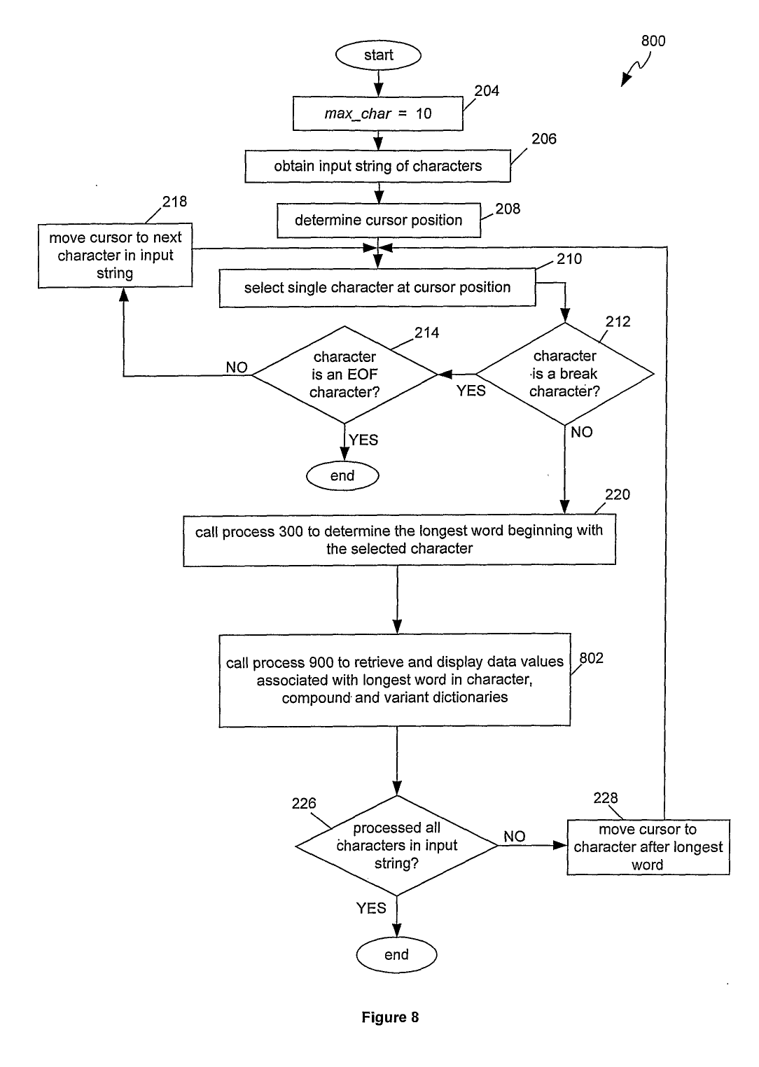

The flow diagram in FIG. 8 shows the process 800 for processing an input string received from the character input module 102 in order to display descriptive data from the dictionary (e.g. 116, 118 and/or 120) associated with words or phrases identified in the input string. Process 800 processes the input string to identify a compound word (including a phrase) starting with a particular character in an input string, and then descriptive data is retrieved for the longest word and also for each word contained within that longest word. Process 800 is a variant of process 200, where like numbers in both FIGS. 2 and 8 refer to the same steps. Process 800, however, does not have a corresponding step 216 or step 222, which exist only in process 200. Process 800 is executed in the tokenisation module 108. Process 800 begins at step 204 and executes the same way as described above in relation to process 200. However, step 220 in process 800 proceeds to the new step 802, where process 900 is called to retrieve and display the data values associated with the longest word which are defined in the character, compound and/or variant dictionaries 116, 118 and/or 120. Also, after step 802, the process then proceeds to step 226.

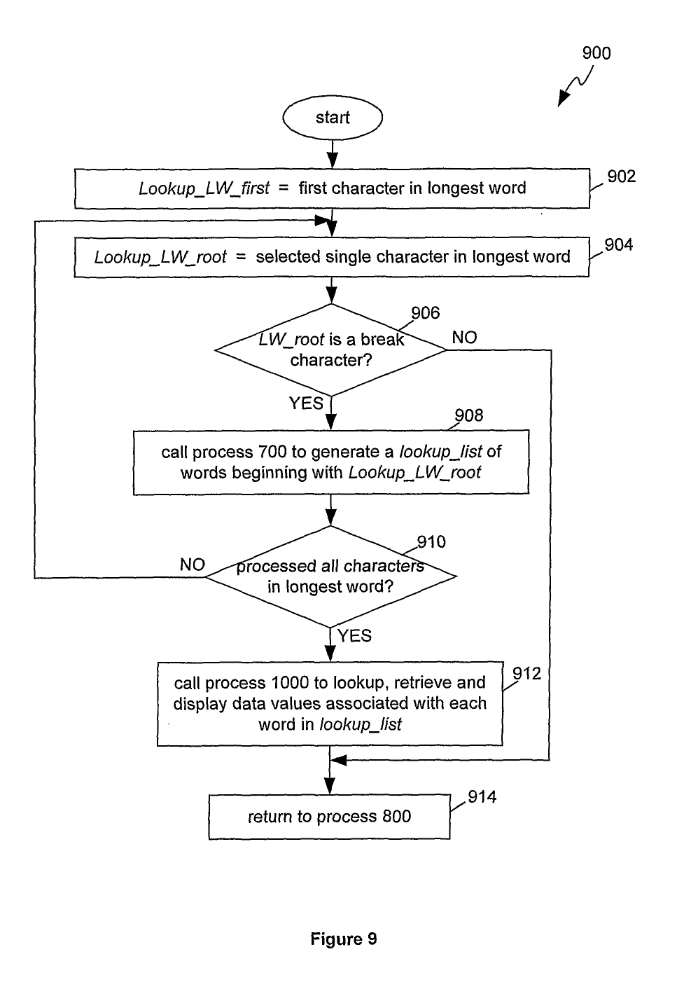

The flow diagram in FIG. 9 shows the process 900 for generating a list of words that are contained within the longest word. The steps in process 900 are executed in the tokenisation module 108. Process 900 begins at step 902, where the first character in the longest word is defined as the variable, Lookup_LW_first. At step 904, a root character is selected which is used as the starting point for generating a list of compound words beginning with that root character. At step 904, the variable Lookup_LW_root, representing the root character, is initially defined as the first character in the longest word. It is then determined, at step 906, whether the character defined as Lookup_LW_root is a break character. If so, step 906 proceeds to step 914, where execution resumes at step 226 of process 800. Otherwise step 906 proceeds to step 908, where process 700 is used to generate a list of one or more compound words, each of which starts with the character defined as Lookup_LW_root, and each compound word is made up of the character in the input string consecutively following and including the character defined as Lookup_LW_root. Each of the compound words formed are stored in a list, identified by the handle, lookup_list. After a list of words has been generated, step 910 determines whether all the characters in the longest word have been processed (i.e. whether each character in the longest word has been defined as Lookup_LW_root to generate a list of words starting from that character). If not, step 910 proceeds to step 904, where the next character in the input string immediately following the character currently defined as Lookup_LW_root is selected as the new root character, and the variable Lookup_LW_root is then updated to refer to the new root character. Otherwise, step 910 proceeds to step 912, where process 1000 is used to process the lookup_list of compound words by looking up and retrieving (from the character, compound and/or variant dictionaries 116, 118 and/or 120) data corresponding to each entry in the lookup_list, and generating display data for displaying the retrieved data. Step 912 then proceeds to step 914.

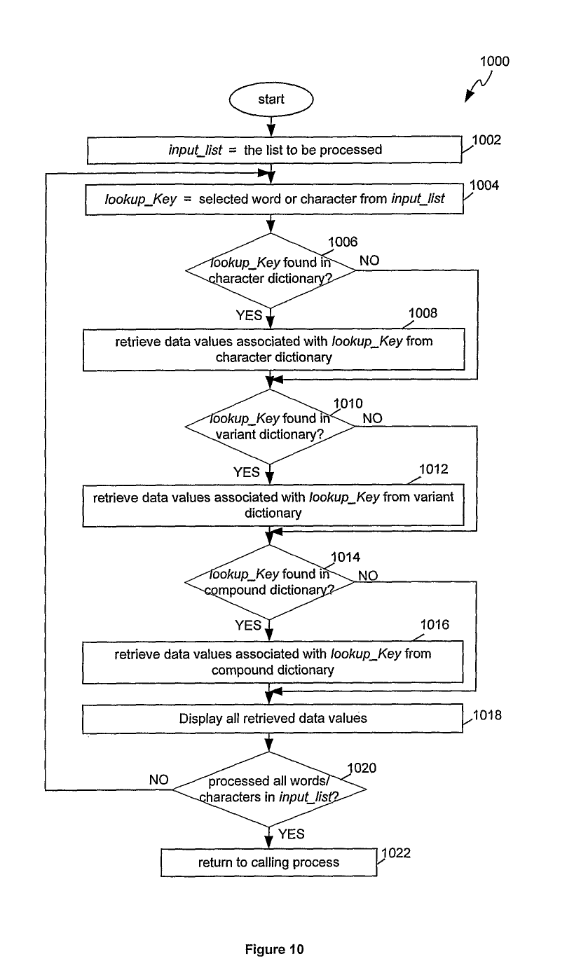

The flow diagram in FIG. 10 shows the process 1000 for looking up and retrieving data from the character, compound and/or variant dictionaries 116, 118 and/or 120 corresponding to each entry in a list, which contains one or more individual characters and/or one or more compound words or phrases. The steps in process 1000 are executed in the lookup module 112, except step 1020 is executed in the display module 106. Process 1000 begins at step 1002, where the variable, input_list, is defined as a temporary handle for accessing a list (containing one or more entries, each corresponding to an individual character or compound word) to be processed. For example, input_list may be a pointer to an existing list (such as a list generated by process 700, 1100, 1200 or 1300). At step 1004, a single entry corresponding to a character or a compound word is selected from the input_list, which is then stored in the variable, lookup_Key. Step 1006 uses the contents of lookup_Key is used to lookup the character dictionary 116 for an entry corresponding to the lookup_Key. At step 1006, the Unicode character code representation of the single character in lookup_Key, or the Unicode character codes for each character in lookup_Key (concatenated in their order of appearance in lookup_Key), to lookup the character dictionary 116. If no entry is found in the character dictionary 116, step 1006 proceeds to step 1010. Otherwise, step 1006 proceeds to step 1008, where the data values in the character dictionary 116 associated with the character entry identified by lookup_Key are retrieved (i.e. by looking up the values contained in the one or more objects corresponding to the character dictionary 116). Data values that may be retrieved from the character dictionary 116 include the Unicode character code for the character corresponding to the identified character entry, the phonetic data representing one or more phonetic representations (e.g. in pinyin) corresponding to the identified character entry, audio data representing the audio representation of the character corresponding to the identified character entry and/or definition data representing the one or more translation strings corresponding to the identified character entry. Other data values defined in the character dictionary 116 may also be retrieved. Step 1008 proceeds to step 1010.

At step 1010, the single character or compound word stored in lookup_Key is used to lookup the variant dictionary 120 for a corresponding entry identified by lookup_Key. Step 1010 uses the Unicode character code representation of the single character in lookup_Key, or the Unicode character codes for each character in lookup_Key (concatenated in their order of appearance in lookup_Key), to lookup the variant dictionary 120. If no entry is found in the variant dictionary 120, step 1010 proceeds to step 1014. Otherwise, step 1010 proceeds to step 1012, where the data values in the variant dictionary 120 associated with an entry identified by lookup_Key are retrieved (i.e. by looking up the values contained in the one or more objects corresponding to an entry in the variant dictionary 120). Data values that may be retrieved from the variant dictionary 120 include the simplified variant character, one or more traditional variant characters, and/or one or more semantic variant characters corresponding to a particular character entry. Other data values defined in the variant dictionary 120 may also be retrieved. Step 1012 proceeds to step 1014.

At step 1014, the single character or compound word stored in lookup_Key is used to lookup the compound dictionary 118 for a corresponding entry identified by lookup_Key. Step 1014 uses the Unicode character code representation of the single character in lookup_Key, or the Unicode character codes for each character in lookup_Key (concatenated in their order of appearance in lookup_Key), to lookup the compound dictionary 118. If no entry is found in the compound dictionary 118, step 1014 proceeds to step 1018. Otherwise, step 1014 proceeds to step 1016, where the data values in the compound dictionary 118 associated with an entry identified by lookup_Key are retrieved (i.e. by looking up the values contained in the one or more objects corresponding to the compound word entry in the compound dictionary 118). Data values that may be retrieved from the compound dictionary 118 include the unique combination of Unicode character codes identifying the identified compound word entry, the phonetic data representing a phonetic representation (e.g. in pinyin) corresponding to the identified compound word entry, audio data representing an audio representation (e.g. as audio signal) of the compound word corresponding to the identified compound word entry and/or definition data representing the translation string corresponding to the identified compound word entry. Other data values defined in the compound dictionary 118 may also be retrieved. Step 1016 proceeds to step 1018.

Step 1018 generates display data for the display module 106 to display all the retrieved data values corresponding to lookup_Key (e.g. the Unicode character code(s), phonetic data, audio data, definition data, a simplified variant character, traditional variant characters and/or semantic variant characters). Step 1020 determines whether each word in the input_list has been processed (i.e. used as the lookup_Key). If not, step 1020 proceeds to step 1004, where the next entry in the input_list is selected and defined as the new value of lookup_Key, and the new value of lookup_Key is processed according to the steps in process 1000 as described above. Otherwise, step 1020 proceeds to step 1022, where execution resumes in the process which made the call to execute process 1000.

The flow diagram in FIG. 11 shows the process 1100 for generating a list of entries, each entry corresponding to a single character or a compound word, using the pinyin syllables derived from an input string containing one or more pinyin syllables. The steps in process 1100 are executed in the tokenisation module 108, except steps 1108 and 1110 which are executed in the lookup module 112, and step 1114 is executed, in part, in the lookup and display modules 112 and 106. Process 1100 begins at step 1102, where an input string of pinyin syllables is obtained from the user. For example, the user may enter one or more pinyin syllables into an input field of the character input module 102. As described above, a pinyin syllable has at least a text component (to represent the sound or pronunciation of the syllable), and preferably, also has a tone component corresponding to the text component. For instances, a pinyin syllable may be entered as “kou3”, where “kou” corresponds to the text component and “3” is a numeric identifier corresponding to the tone component. Preferably, the pinyin syllable is entered in the format “text#”, where the word “text” represents the text component of the syllable, and the “#” symbol represent an integer which is used to identify the tone component. Preferably further, if only the text component of a pinyin syllable is entered without a corresponding tone, then in the lookup process described below it will be assumed that separate searches are conducted for every combination of tones that can be formed with the text component entered by the user. The pinyin used may be the standard Putonghua pinyin. However, it will be understood that the present invention can also work with other pinyin or other forms of phonetic representation of characters.

At step 1104, the input string of pinyin syllables is parsed in order to identify each pinyin syllable in the input string, and for each syllable, the corresponding text and tone components. For example, pinyin syllables are typically entered with a space between each syllable, and so the parsing in step 1104 may involve tokenising the input string of pinyin syllables based on the location of the space character in that string. Step 1106 determines whether the input string contains only one pinyin syllable (i.e. whether the pinyin from the input string corresponds to a single character, or a compound word or phrase). If there is only one pinyin syllable in the input string, step 1106 proceeds to step 1108, where the value of the pinyin data field for each entry in the character dictionary 116 is searched and only the characters (e.g. the Unicode character code) which have a pinyin data field corresponding to the entered pinyin syllable are retrieved. At step 1112, the retrieved characters are added to a list referred to by the handle, pinyin_list.

Otherwise, if step 1106 determines that the input string contain more than one pinyin syllable, the input string must correspond to a compound word or phrase, step 1106 proceeds to step 1110. At step 1110, each entry in the compound dictionary 118 is searched to retrieve only those compound words (including phrases) which have a pinyin representation (formed by the concatenation combination corresponding to the each of the entered pinyin syllables in their order of entry. If the pinyin representation of a compound word (or phrase) in the compound dictionary 118 contains within it each of the entered pinyin syllables in their order of entry, then that compound word is also retrieved at step 1110. At step 1112, the retrieved compound words are added to a list referred to by the handle, pinyin_list.

Step 1112 then proceeds to step 1114, where process 1000 is used to lookup, retrieve and display the data values associated with each entry in the pinyin_list, using the data values defined in the character and/or compound dictionaries 116 and 118. After step 1114, process 1100 ends.

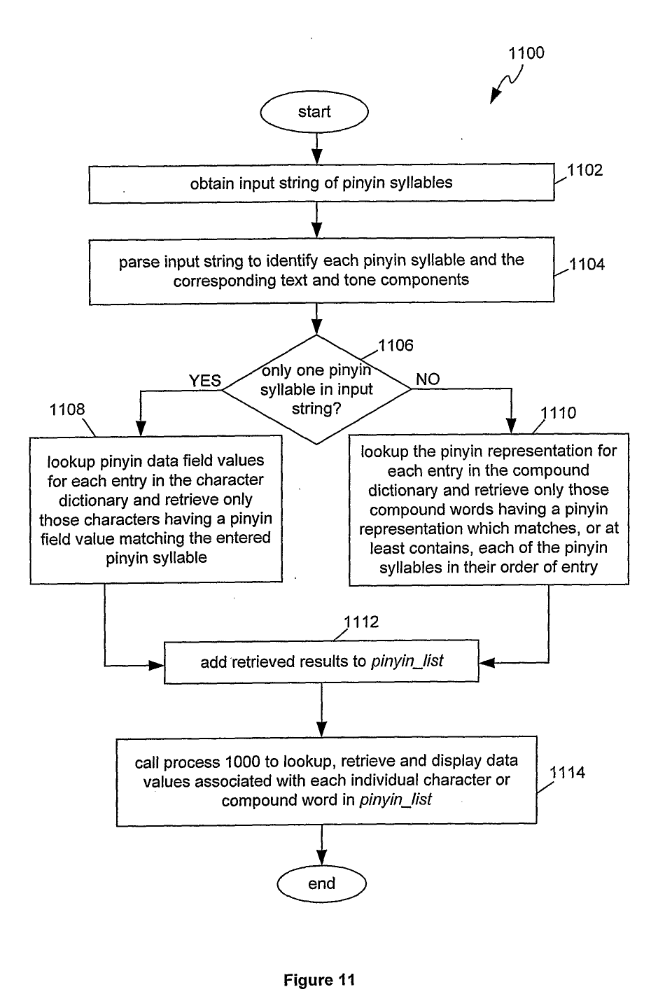

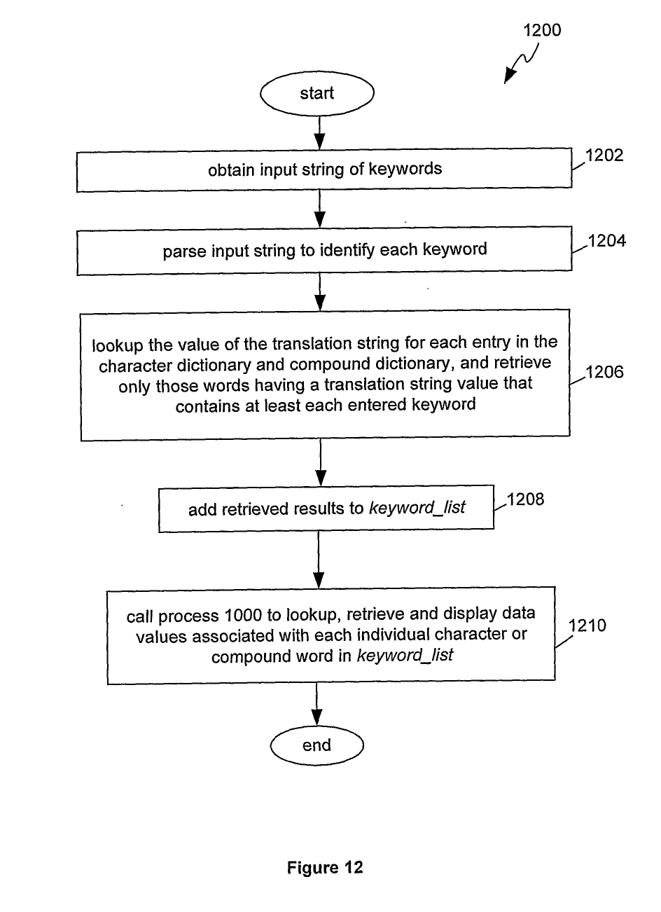

The flow diagram in FIG. 12 shows the process 1200 for generating a list of entries, each entry corresponding to a single character or a compound word, using keywords derived from an input string. The steps in process 1200 are executed in the tokenisation module 108, except step 1206 is executed in the lookup module 112, and step 1210 is executed, in part, in the lookup and display modules 112 and 106. Process 1200 begins at step 1202, where an input string of keywords is obtained from the user. For example, the user may enter one or more keywords into an input field of the character input module 102. Generally, a keyword refers any word which a user regards as being related to the meaning of the character or compound word which the user is trying to retrieve. At step 1204, the input string is parsed in order to identify each of the one or more keywords from the input string. At step 1206, definition data (e.g. the translation string associated with each entry in the character dictionary 116 and/or the compound dictionary 118) is searched, and a character or compound word is retrieved (from the dictionary 116 or 118) only if the corresponding translation string contains at least some of the entered keywords. At step 1208, the retrieved characters and/or compound words are added to a list referred to by the handle, keyword_list. Then, at step 1210, process 1000 is used to lookup, retrieve and display the data values associated with each entry in the keyword_list, using the data values defined in the character and/or compound dictionaries 116 and 118. After step 1210, process 1200 ends.

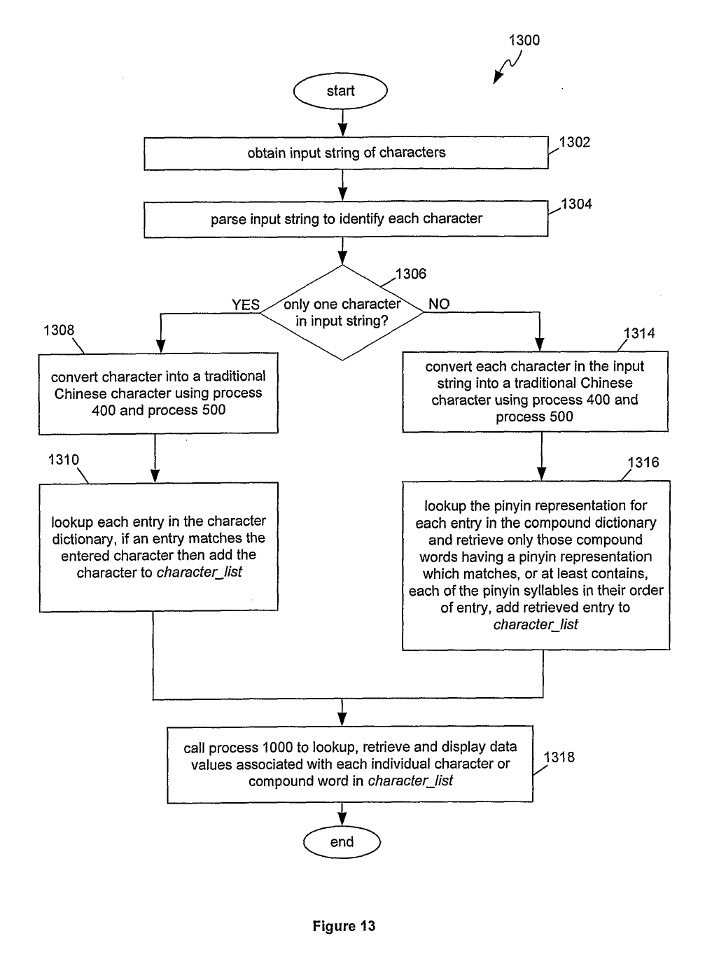

The flow diagram in FIG. 13 shows the process 1300 for generating a list of entries, each entry corresponding to a single character or a compound word, using the characters derived from an input string of characters. The steps in process 1300 are executed in the tokenisation module 108, except steps 1308, 1310, 1314 and 1316 are executed in the lookup module 112, and step 1318 is executed, in part, in the lookup and display modules 112 and 106. Process 1300 begins at step 1302, where an input string of Chinese characters is obtained from the user. For example, the user may enter one or more Chinese characters into an input field of the character input module 102. At this stage, the characters entered by the user can be either traditional or simplified Chinese characters. At step 1304, the input string is parsed in order to identify each of the one or more characters in the input string (e.g. by determining the Unicode character code for each character entered as the input string). Step 1306 determines whether the input string contains only one character. If the input string contains only one character, step 1306 proceeds to step 1308, where that character is converted into a traditional Chinese character using either or both process 400 and process 500. At step 1310, the Unicode character code corresponding to the character returned from process 400 or process 500 is used to lookup each entry in the character dictionary 116. If an entry in the character dictionary 116 matches the Unicode character code of the entered character, then at step 1310, the entered character is added to a list identified by the handle, character_list.

Otherwise, if step 1306 determines that the input string contains more than one character, then the characters in the input string are treated as a compound word and step 1306 proceeds to step 1314. At step 1314, each character in the input string is converted into a traditional Chinese character using either or both process 400 and process 500. At step 1316, a key is formed using the Unicode character codes for each enter character in the input string, which are concatenated according to their order of entry in the input string. The key is used to lookup the compound dictionary 118 for a matching entry. If a matching entry is found, then at step 1316, the compound word in the input string is added to a list identified by the handle, character_list.

After step 1310 or step 1316, the process proceeds to step 1318, where process 1000 is used to lookup, retrieve and display the data values associated with each entry in the pinyin_list, using the data values defined in the character and/or compound dictionaries 116 and 118. After step 1318, process 1300 ends.

The step of converting a character into a traditional Chinese character is only an optional feature in some of the preferred embodiments of the present invention which are adapted for processing Chinese characters. It will be understood that those steps are not required if the dictionary entries contain entries that are identified by the Unicode character codes for a traditional Chinese character as well as its corresponding simplified Chinese character.

Listing 1

<?xml version=“1.0” encoding=“UTF-8” ?>
<allGlyphs>

...
<glyph>

<unicode>53e3</unicode>
<pinyin>kou3</pinyin>
<kDefinition>mouth; opening; entrance; cut; hole;

the edge of a knife;</kDefinition>
</glyph>
...

</allGlyphs>

Listing 2

<?xml version=“1.0” encoding=“UTF-8” ?>
<allGlyphs>

...
<glyph>

<unicode>4f9b</unicode>
<pinyin>gong1</pinyin>
<kDefinition>supply; provide;</kDefinition>
<pinyin>gong4</pinyin>
<kDefinition>lay (offerings); confess; own

up;</kDefinition>

</glyph>
...

</allGlyphs>

Listing 3

<?xml version=“1.0” encoding=“UTF-8” ?>
<allCompounds>

...
<compound>

<tuple pinyin=“ming2” unicode=“660e” />
<tuple pinyin=“tian1” unicode=“5929” />
<english>tomorrow</english>

</compound>
...

</allCompounds>

Listing 4

<?xml version=“1.0” encoding=“UTF-8” ?>
<allGlyphs>

...
<glyph>

<unicode>9452</unicode>
<kSimplifiedVariant>9274</kSimplifiedVariant>
<kSemanticVariant>9451</kSemanticVariant>

</glyph>
...
<glyph>

<unicode>9274</unicode>
<tradVariant>9452 9451</tradVariant>

</glyph>
...
<glyph>

<unicode>9451</unicode>
<kSimplifiedVariant>9274</kSimplifiedVariant>
<kSemanticVariant>9452</kSemanticVariant>

</glyph>
...

</allGlyphs>

Many modifications will be apparent to those skilled in the art without departing from the scope of the present invention as hereinbefore described with reference to the accompanying drawings.

The reference to any prior art in this specification is not, and should not be taken as, an acknowledgment or any form of suggestion that that prior art forms part of the common general knowledge in Australia.

1. A method for generating display data for a user interface, said method including:
(i) receiving an input string including ideographic characters;
(ii) selecting an ideographic character from said input string;
(iii) generating a first word or phrase starting from said selected character, said first word or phrase corresponding to the largest plurality of consecutive ideographic characters from said input string corresponding to a word or phrase in a dictionary;
(iv) generating additional words or phrases based on a plurality of consecutive ideographic characters from said input string starting from a character in said first word or phrase, for each character in said first word or phrase, each said additional word or phrase corresponding to a word or phrase in said dictionary; and
(v) generating said display data for displaying a set of consecutive characters from said input string on said user interface, said set including all the characters from said first word or phrase and said additional words or phrases, said set being displayed based on the location of said additional words or phrases relative to said first word or phrase.

2. A method as claimed in claim 1, wherein said ideographic characters are Chinese characters.

3. A method as claimed in claim 1, wherein said display data represents said set of characters for display on said user interface according to a different display criteria based on the location of said additional words or phrases relative to said first word or phrase.

4. A method as claimed in claim 3, wherein said display data represents said set of characters for display on said user interface according to a first display criteria if said first word or phrase does not include any of the characters in said additional words or phrases.

5. A method as claimed in claim 4, wherein said display data represents said set of characters for display on said user interface according to a second display criteria if said first word or phrase includes all the characters in said additional words or phrases.

6. A method as claimed in claim 5, wherein said display data represents said set of characters for display on said user interface according to a third display criteria if said first word or phrase includes at least some, but not all, of the characters in said additional words or phrases.

7. A method as claimed in claim 3, wherein said display criteria defines one or more visual characteristics for said set of characters, including:
the font size and/or font type for said set of characters;
the style for said set of characters, including defining said set of characters for display in bold, italics and/or with underlining; and/or
the background on which said set of characters are displayed, including a coloured background.

8. A method as claimed in claim 2, wherein said characters in said first word or phrase are converted into traditional Chinese characters for determining whether said first word or phrase corresponds to a word or phrase in said dictionary.

9. A method as claimed in claim 2, wherein said characters in said additional words or phrases are converted into traditional Chinese characters for determining, for each additional word or phrase, whether one of said additional words or phrases corresponds to a word or phrase in said dictionary.

10. A method as claimed in claim 1, including displaying said set of consecutive characters on said user interface based on said display data.

11. A method as claimed in claim 1, said method further including:
(vi) retrieving dictionary data associated with said first word or phrase from said dictionary, said dictionary data including definition data, audio data and/or phonetic data;
(vii) generating additional display data for display on said user interface, said additional display data including at least one representation of said first word or phrase based on said dictionary data.

12. A method as claimed in claim 11, including displaying said at least one representation of said first word or phrase on said user interface based on said additional display data.

13. A method as claimed in claim 11, wherein said additional display data represents:
text for describing said first word or phrase, based on said definition data derived from said dictionary data;
an audio signal for representing said first word or phrase, based on said audio data derived from said dictionary data; and/or
a phonetic representation of said first word or phrase, said phonetic representation including pinyin, based on said phonetic data derived from said dictionary data.

14. A method as claimed in claim 11, said method further including:
(vi)(a) retrieving additional dictionary data associated with one of said additional words or phrases, said additional dictionary data including definition data, audio and/or phonetic data;
(vii)(a) generating said additional display data for display on said user interface, said additional display data further including at least one representation for said additional word or phrase based on said additional dictionary data.

15. A method as claimed in claim 14, including displaying said at least one representation of said additional word or phrase on said user interface based on said additional display data.

16. A method as claimed in claim 14, wherein said additional display data represents:
text for describing said additional word or phrase, based on said definition data derived from said additional dictionary data;
an audio signal for representing said additional word or phrase, based on said audio data derived from said additional dictionary data; and/or
a phonetic representation of said additional word or phrase, said phonetic representation including pinyin, based on said phonetic data derived from said additional dictionary data.

17. A system for performing a method as claimed in claim 1.

18. A computer readable storage medium containing computer executable code for performing a method as claimed in claim 1.

19. A system for generating display data for a user interface, including:
(i) means for receiving an input string including ideographic characters;
(ii) means for selecting an ideographic character from said input string;
(iii) a memory for storing the dictionary;
(iv) a word generator for:
generating a first word or phrase starting from said selected character, said first word or phrase corresponding to the largest plurality of consecutive ideographic characters from said input string which corresponds to a word or phrase in said dictionary; and
generating additional words or phrases starting from a character in said first word or phrase, for each character in said first word or phrase, each said additional word or phrase being generated based on a plurality of consecutive ideographic characters from said input string, and each said additional word or phrase corresponding to a word or phrase in said dictionary; and
(v) means for generating said display data for displaying a set of consecutive characters from said input string on said user interface, said set including all the characters from said first word or phrase and said additional words or phrases, wherein the displaying of said set of characters is based on the location of said additional words or phrases relative to said first word or phrase.

20. A system as claimed in claim 19, wherein said means for generating said display data generates display data for displaying said set of character on said user interface according to a different display criteria based on the location of said additional words or phrases relative to said first word or phrase.

21. A system as claimed in claim 19, including said user interface for displaying said set of consecutive characters based on said display data.

22. A system as claimed in claim 19, further including:
(vi) means for retrieving dictionary data associated with said first word or phrase from said dictionary, said dictionary data including definition data, audio data and/or phonetic data; and
wherein said means for generating said display data includes means for generating additional display data, said additional display data including at least one representation of said first word or phrase, based on said dictionary data, for display on said user interface.

23. A system as claimed in claim 22, including said user interface for displaying said at least one representation of said first word or phrase based on said additional display data.

24. A system as claimed in claim 22, wherein said additional display data represents:
text for describing said first word or phrase, based on said definition data derived from said dictionary data;
an audio signal for representing said first word or phrase, based on said audio data derived from said dictionary data; and/or
a phonetic representation of said first word or phrase, said phonetic representation including pinyin, based on said phonetic data derived from said dictionary data.

25. A system as claimed in claim 22, further including:
(vii) means for retrieving additional dictionary data associated with one of said additional words or phrases, said additional dictionary data including definition, audio and/or phonetic data;
wherein said means for generating said additional dictionary data generates said additional dictionary data that further includes at least one representation for said additional word or phrase, based on said additional dictionary data, for display on said user interface.

26. A system as claimed in claim 25, including said user interface for displaying said at least one representation of said additional word or phrase based on said additional dictionary data.

27. A system as claimed in claim 25, wherein said additional dictionary data represents:
text for describing said additional word or phrase, based on said definition data derived from said additional dictionary data;
an audio signal for representing said additional word or phrase, based on said audio data derived from said additional dictionary data; and/or
a phonetic representation of said additional word or phrase, said phonetic representation including pinyin, based on said phonetic data derived from said additional dictionary data.
